(19) United States
(12) Patent Application Publication
(10) Pub. No.: US 2023/0256978 A1
(43) Pub. Date: Aug. 17, 2023

(54) AN AUTOMOBILE CONTROL SYSTEM

(71) Applicant: INEOS AUTOMOTIVE LIMITED, Lyndhurst (GB)

(72) Inventor: Vishal Lalwani, Böblingen (DE)

(73) Assignee: INEOS AUTOMOTIVE LIMITED, Lyndhurst (GB)

(21) Appl. No.: 18/009,190

(22) PCT Filed: Jun. 9, 2021
(86) PCT No.: PCT/GB2021/051433

§ 371 Date: Dec. 8, 2022

(30) Foreign Application Priority Data
Jun. 9, 2020 (GB) 2008723.5
Jun. 9, 2020 (GB) 2008727.6

(51) Int. Cl. B60W 50/00; B60W 30/182; B60W 40/105; B60W 50/16

(52) U.S. Cl. CPC B60W 50/0098; B60W 30/182; B60W 40/105; B60W 50/16; B60W 2050/0005; B60W 2050/0095; B60W 2050/143

(57) ABSTRACT

The disclosure relates to an automobile control system and associated automobile, method and computer program. The automobile control system comprising: one or more homologation-relevant subsystems (206, 208, 210); and a processor (204) configured to: configure the one or more homologation-relevant subsystems of an automobile when the automobile is in a non-compliant mode of operation so as not to satisfy a homologation requirement; automatically switch control of the automobile from the non-compliant mode of operation to a compliant mode of operation based on an operating parameter of the automobile; and configure the one or more homologation-relevant subsystems of the automobile when the automobile is in the compliant mode of operation so as to satisfy the homologation requirement. In a particularly relevant configuration, the non-compliant mode of operation is an off-road driving mode and the subsystem is an engine stop-start system.

The present disclosure relates to at least one of an automobile control system, an automobile comprising the automobile control system, a method and a computer program. In particular, the present disclosure relates to an automobile control system comprising one or more homologation-relevant subsystems and a processor and an automobile control system comprising a multi-core processor.

### SUMMARY

According to a first aspect of the present disclosure, there is provided an automobile control system comprising:
one or more homologation-relevant subsystems; and
a processor configured to:
configure the one or more homologation-relevant subsystems of an automobile when the automobile is in a non-compliant mode of operation so as not to satisfy a homologation requirement;
automatically switch control of the automobile from the non-compliant mode of operation to a compliant mode of operation based on an operating parameter of the automobile; and
configure the one or more homologation-relevant subsystems of the automobile when the automobile is in the compliant mode of operation so as to satisfy the homologation requirement.

Such an automobile control system may facilitate greater customisation of an automobile for the non-compliant mode of operation, in particular with respect to not satisfying a homologation requirement. This can result in improved performance of the automobile when it is in the non-compliant mode of operation, for example in terms of improved reliability overall (in every mode of operation), and in terms of safety and/or comfort (when in the non-compliant mode of operation).

Configuring the one or more homologation-relevant subsystems of the automobile when the automobile is in the compliant mode of operation may comprise one of activating, enabling, or initiating for operation the one or more homologation-relevant subsystems. Configuring the one or more homologation-relevant subsystems of the automobile when the automobile is in the non-compliant mode of operation may comprise one of deactivating, disabling, disengaging or inhibiting from operation the one or more homologation-relevant subsystems.

Satisfying or not satisfying the at least one homologation requirement may comprise complying or not complying with the homologation requirement.

The homologation requirement may be a legal requirement based on an emissions standard, a safety standard, or an ISO standard or a combination thereof.

The one or more homologation-relevant subsystems may be selected from the group consisting of advanced driver-assistance system, an air bag system, an automatic transmission lock, a camera system, a diesel particulate filter, a door status detection system, a dynamic stability control system, an electronic stability program, a gasoline particulate filter, a lighting system, a parking distance control system, a parking lock, a seatbelt indicator and a stop-start system.

The processor may be configured to:
receive the operating parameter of the automobile;
determine when the operating parameter exceeds a threshold parameter; and
automatically switch control of the automobile from the non-compliant mode of operation to the compliant mode of operation when the operating parameter exceeds the threshold parameter.

The operating parameter may be a speed of the automobile. The threshold parameter may be a threshold speed parameter. The threshold speed parameter may be at least 5 km/hr.

The automobile control system may comprise at least one sensor configured to: sense the operating parameter of the automobile; and provide sensor data to the processor. The processor may be configured to: receive the sensor data from the sensor; and determine when the operating parameter exceeds a threshold parameter based on the sensor data.

The non-compliant mode of operation may comprise the automobile being on.

The processor may be configured to:
receive an indication of an operating state of the automobile; and
switch control of the automobile from the non-compliant mode of operation to the compliant mode of operation based on the operating state satisfying an operating-state-condition.

Satisfying the operating-state-condition may require the operating state being in an off state for at least a minimum period of time.

The processor may be configured to provide an indication to a user of the automobile when automatically switching control of the vehicle from the non-compliant mode of operation to the compliant mode of operation.

There may be provided an automobile comprising any automobile control system disclosed herein.

There may be provided a computer-implemented method of controlling an automobile, the automobile comprising one or more homologation-relevant subsystems, the method comprising:
configuring the one or more homologation-relevant subsystems of the automobile when the automobile is in a non-compliant mode of operation so as not to satisfy a homologation requirement;

automatically switching control of the automobile from the non-compliant mode of operation to a compliant mode of operation based on an operating parameter of the automobile; and
configuring the one or more homologation-relevant subsystems of the automobile when the automobile is in the compliant mode of operation so as to satisfy the homologation requirement.

According to a further aspect of the present disclosure, there is provided an automobile control system comprising:
a multi-core processor comprising a plurality of cores,
   wherein:
at least one core of the plurality of cores is pre-allocated for use with at least one safety critical function of an automobile, the at least one safety critical function configured to comply with an automotive safety integrity level, ASIL,
at least one other core of the of the plurality of cores is pre-allocated for use with at least one non-safety critical function of the automobile, and
the multi-core processor is configured to route a request from the at least one safety critical function to the at least one core that is pre-allocated for use with the at least one safety critical function.

Such an automobile control system can advantageously ensure that the multi-core processor has sufficient resource to service the at least one safety critical function in a quick and efficient manner.

In one or more embodiments the request may comprise a request identifier identifying the at least one safety critical function. The multi-core processor may be configured to route the request based on the request identifier.

In one or more embodiments the multi-core processor may be configured to determine which of the plurality of cores to route the request to by accessing a look-up table using the request identifier.

In one or more embodiments the multi-core processor may be configured to route a request from the at least one non-safety critical function to the at least one other core.

In one or more embodiments the multi-core processor may be configured to preclude routing of a request from the at least one non-safety critical function to the at least one core that is pre-allocated for use with the at least one safety critical function.

In one or more embodiments the ASIL of the function may be one of A, B, C or D as defined under ISO 26262.

In one or more embodiments each core of the multi-core processor may be physically distinct from each other core.

In one or more embodiments the at least one safety critical function may be selected from the group comprising: an airbag function, a brake function, an engine temperature warning function, a tyre pressure monitor, an engine warning function, a battery warning function, an oil level monitor, a coolant level monitor, an electronic stability control function, and an emergency telephony function.

In one or more embodiments the at least one non-safety critical function may be selected from the group comprising: a multi-media function, an AM/FM radio, a digital radio, a global navigation satellite receiver, a wireless router, an audio function, a body control module, a rear view camera and a USB hub.

In one or more embodiments the at least one core may be configured to receive an operating state of the at least one safety critical function, and provide an indication of, or calculation based on, the safety critical function. The at least one other core may be configured to: receive an operating state of the at least one non-safety critical function, and provide an indication of, or calculation based on, the non-safety critical function.

In one or more embodiments the at least one core and the at least one other core may be configured to provide the indication of the safety critical function operating state and the indication of the non-safety critical function operating state for display on at least one display.

In one or more embodiments the at least one display may comprise a first display and a second display. The first display may be configured to display the indication of the at least one safety critical function. The second display may be configured to display the indication of the at least one non-safety critical function, and/or the indication of the at least one safety critical function.

In one or more embodiments the multi-core processor may be configured to process requests from the at least one safety critical function and the at least one non-safety critical function simultaneously.

In one or more embodiments the multi-core processor may comprise at least two cores pre-allocated for use with the at least one safety critical function.

In one or more embodiments the multi-core processor may be configured to route the request from the at least one safety critical function to a core of the at least two cores based on processor availability.

In one or more embodiments the multi-core processor may comprise at least wo cores pre-allocated for use with the at least one non-safety critical function.

In one or more embodiments the automobile control system may comprise a system configured to call the at least one safety critical function, and/or the at least one non-safety critical function.

According to a further aspect of the present disclosure, there is provided an automobile comprising any automobile control system disclosed herein.

According to a further aspect of the present disclosure, there is provided a method of configuring an automobile control system comprising a multi-core processor, the multi-core processor comprising a plurality of cores, the method comprising:
receiving a request from a function; and
routing the request to a pre-allocated core of the plurality of cores based on whether the request is from a function that is either: (i) a safety critical function of an automobile, or (ii) a non-safety critical function of the automobile,
wherein the safety critical function is configured to comply with an automotive safety integrity level, ASIL.

There may be provided a computer program, which when run on a computer, causes the computer to configure any apparatus, including a circuit, controller, converter, or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an Internet download. There may be provided one or more non-transitory computer-readable storage media storing computer-executable instructions that, when executed by a computing system, causes the computing system to perform any method disclosed herein.

### BRIEF DESCRIPTION OF THE DRAWINGS

One or more embodiments will now be described by way of example only with reference to the accompanying drawings in which:

FIG. 1 shows an example automobile comprising an automobile control system;

FIG. 2 shows an example schematic of an automobile control system;

FIG. 3 shows a further example schematic of an automobile control system;

FIG. 4 shows a further example schematic of an automobile control system;

FIG. 5 shows an example method of the present disclosure;

FIG. 6 shows an example automobile comprising an automobile control system;

FIG. 7 shows an example schematic of an automobile control system;

FIG. 8 shows an example method of the present disclosure;

FIG. 9 shows a further example schematic of an automobile control system;

FIG. 10 shows a further example schematic of an automobile control system;

FIG. 11 shows a further example schematic of an automobile control system; and

FIG. 12 shows a further example method of the present disclosure.

### DESCRIPTION—HOMOLOGATION-RELEVANT SUBSYSTEMS

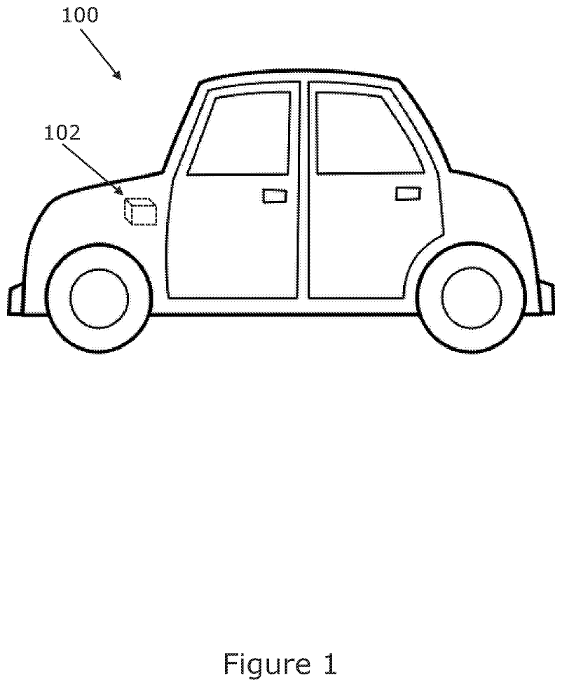

FIG. 1 shows an example automobile 100 comprising an automobile control system 102. The automobile control system 102 comprises one or more homologation-relevant subsystems and a processor (not shown).

A subsystem may be understood as being ‘homologation-relevant’ if it is applicable to a homologation requirement. The homologation requirement may be a legal requirement, for example based on an automotive standard, a safety standard or an emissions standard or a combination thereof that an automobile must satisfy when in a compliant mode of operation (e.g., a road legal mode). As such, the homologation requirement may vary on a jurisdiction-by-jurisdiction basis.

Further examples of a homologation requirement, in addition to examples of homologation-relevant subsystems, are described later in the present disclosure.

It has been unexpectedly found that if an automobile control system is configured to operate all homologation-relevant subsystems such that a homologation requirement is always satisfied for all modes of automobile operation, then this may increase the likelihood of an accident or automobile damage in at least some of these modes (for example off-road or wading modes). Furthermore, there has been no teaching or expectation that a homologation requirement could be discounted (not satisfied) when an automobile is in any mode of operation.

According to examples disclosed herein, an automobile may be configured for a non-compliant mode of operation. The automobile may be used in such a non-compliant mode of operation when it is off-road, for example, in which case it is not required to meet a homologation requirement.

An objective of one or more embodiments disclosed herein is to provide an automobile control system that can improve one or more of automobile safety, reliability and customisation for a variety of modes of operation.

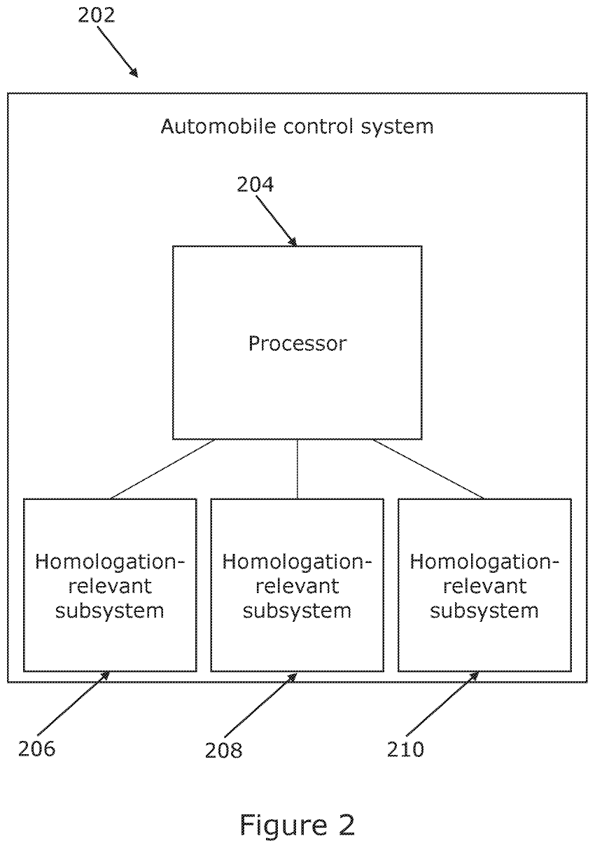

FIG. 2 shows an example schematic of an automobile control system 202. The automobile control system 202 comprises a processor 204 and one or more homologation-relevant subsystems 206, 208, 210.

The processor 204 is configured to automatically switch control of an automobile from a non-compliant mode of operation to a compliant mode of operation based on an operating parameter of the automobile. Alongside an off-road mode, an example of a non-compliant mode of operation is a wading mode, as will be discussed in more detail below. The non-compliant mode of operation may be one in which the automobile is on—that is, not when the automobile is stationary and/or switched off. In some examples, the automobile may be in motion when it is in the non-compliant mode, for example travelling above a minimum speed (e.g., 5 km/hr).

The one or more homologation-relevant subsystems may be selected from the group consisting of an advanced driver-assistance system (ADAS) (examples of which include an automatic emergency brake system (AEB) and a lane keeping assist system (LKS)), an air bag system, a camera system (e.g., a front-, side- or rear-view camera or combination thereof), a diesel particulate filter (DPF), a door status detection system, a dynamic stability control (DSC) system, an electronic stability program (ESP), a gasoline particulate filter (OPF), a lighting system (e.g., a daytime running lights system), a parking distance control (PDC) system, a parking lock, a seatbelt indicator (e.g., warning system) and a stop-start system.

When the automobile is in the compliant mode of operation, the processor 204 is configured to configure one or more homologation-relevant subsystems 206, 208, 210 so as to satisfy an appropriate homologation requirement. The homologation requirement may be based on an emissions standard, a safety standard, a legal requirement, an ISO standard or a combination thereof. The condition ‘to satisfy a homologation requirement’ may comprise being compatible with the homologation requirement, complying with the homologation requirement, and/or configuring the one or more homologation-relevant subsystems 206, 208, 210 so that the subsystem(s) satisfies the homologation requirement. The condition ‘to not satisfy a homologation requirement’ should be understood in a corresponding manner.

For example, when the automobile is in the compliant mode of operation, the processor 204 may activate (e.g., turn on or activate from a standby mode), enable, initiate for operation or increase the functionality of one or more homologation-relevant subsystems 206, 208, 210 so as to satisfy the homologation requirement. When the automobile is in the non-compliant mode of operation, the processor 204 may deactivate (e.g., turn off or deactivate to a standby mode), disable, inhibit from operation or decrease the functionality of the one or more homologation-relevant subsystems 206, 208, 210 so as not to satisfy the homologation requirement.

As will be described later in the present disclosure, the non-compliant mode of operation may be customised by a user of the automobile. That is, the user may select which homologation-relevant subsystem(s) are configured by the automobile control system 202 so as not to satisfy a homologation requirement when the automobile is in the non-compliant mode of operation. In some implementations all such homologation-relevant subsystems can be configurable by the user, for example using an instrument panel cluster configuration menu. In some examples, it may also be possible to configure a homologation-relevant subsystem with a user operable switch and/or a diagnosis tester.

Accordingly, the automobile control system 202 of FIG. 2 may facilitate greater customisation of an automobile for the non-compliant mode of operation, in particular with respect to not satisfying a homologation requirement. This can result in improved performance of the automobile when it is in the non-compliant mode of operation, for example in terms of improved reliability overall (in every mode of operation), and in terms of safety and/or comfort (when in the non-compliant mode of operation).

For example, an off-road mode of operation may correspond to switching off one or more of the following homologation-relevant subsystems: stop-start, parking distance control, door status detection, DSC, ESP, ADAS (LKS, automatic emergency braking), running lights, and configuring a reversing camera for use up to a higher speed than normal (that is, so that a camera is automatically deactivated at a different speed distance than would be the case when in the compliant mode of operation).

A wading mode of operation may correspond to one or more of switching off DPF/OPF regeneration, seatbelt warning, air conditioning, and seat heating systems, alongside activating an air circulation system. Switching off the seat heating system may reduce the likelihood of system malfunction if water enters the automobile compartment.

Activating the air circulation system may reduce the likelihood of suction of water from outside the automobile.

A detailed description of satisfying or not satisfying a homologation requirement will now be provided. As introduced above, when an automobile is in a compliant mode of operation the one of more subsystems may be configured so as to satisfy a homologation requirement. As one example, a homologation requirement may be that all homologation-relevant subsystems of the automobile are active when an automobile is in a compliant mode of operation (e.g., an automatic emergency brake system is on standby, a diesel particulate filter is operational, etc.).

When the automobile is in a wading mode, it may no longer be appropriate or necessary for the homologation-relevant subsystems to satisfy the homologation requirement. If such satisfaction continues (e.g., the homologation-relevant subsystems remain active), however, the users of the automobile may be disturbed or risk being harmed. There may also be a greater likelihood of subsystem damage.

For example, a homologation-relevant electronic subsystem may catastrophically fail if it becomes waterlogged while the automobile is wading through a body of water. A DPF may experience accelerated wear if it undergoes a regeneration cycle during such driving because the likelihood of undesirable rapid quenching by the body of water is higher than for normal driving. In such circumstances, it is advantageous for the automobile control system to configure these homologation-relevant systems such they are in an operating state that is less susceptible to damage when the automobile is in the wading mode, even though doing so results in the automobile no longer satisfying one or more homologation requirements.

In other words, when an automobile is in a non-compliant mode of automobile operation, a homologation requirement need not be satisfied because it is no longer relevant to the use conditions associated with the non-compliant mode. Continued satisfaction of the homologation requirement may even be detrimental to the automobile and/or its users.

A homologation requirement should, nevertheless, be satisfied for the automobile to operate in the compliant mode of operation. Configurations for the non-compliant (wading) mode would be unfeasible for the compliant (road-legal) mode, for example, due to the deactivation of legally required functions in some countries.

As such, one or more embodiments of automobile control systems as set out in the present disclosure may comprise (and realise) one or more of the following:
1. Deactivating a stop-start system when in an off-road and/or wading mode, which can improve functional reliability, add user comfort and increase safety.
2. Deactivating a PDC system in an off-road and/or wading mode, which can add user comfort.
3. Deactivating a DSC system and/or an ESP in an off-road mode.
4. Deactivating one or more ADAS functions in an off-road mode.
5. Configuring a reversing camera for use up to a higher speed than normal in an off-road mode, which can improve functional reliability and add user comfort.
6. Turning off a DPF or OPF regeneration mode in a wading mode (and warning a user as such, as will be described later), which can improve functional reliability.
7. Turning off a seatbelt warning in a wading mode, which can improve functional reliability and safety.
8. Turning off an air conditioning system and an air circulation system in a wading mode, which can improve functional reliability such systems being incompatible with water ingestion and can add user comfort.
9. Deactivating a seat heating system in a wading mode, which can improve functional reliability.
10. Deactivating an automatic transmission lock (auto P-lock) in an off-road and/or wading mode, which can add user comfort and increase safety.

By way of comparison, an engine control unit (ECU) that has been re-mapped (for example, according to an economy or sports mode of operation) would continue to satisfy a homologation requirement because it remains configured for road legal use. That is, the automobile remains in a compliant mode of operation.

As introduced above, the processor 204 is configured to automatically switch control of the automobile from a non-compliant mode of operation to a compliant mode of operation based on an operating parameter of the automobile. In some examples, the processor 204 may be configured to receive the operating parameter of the automobile. The processor 204 may receive the operating parameter from a sensor, or from information that is available on the Controller Area Network (CAN) bus, for example. The processor 204 can then determine when the operating parameter exceeds a threshold parameter and automatically switch control of the automobile from the non-compliant mode of operation to the compliant mode of operation when the operating parameter exceeds the threshold parameter.

In one example, the operating parameter is the speed of the automobile, in which case the threshold parameter is a threshold speed parameter. The threshold speed parameter may be a minimum speed; for example, at least 5 km/hr, 10 km/hr, 20 km/hr, 30 km/hr, 40 km/hr, 50 km/hr, 60 km/hr, 70 km/hr, 80 km/hr, 90 km/hr or 100 km/hr. In this way, the automobile control system 202 may automatically switch control of the automobile when the automobile's speed is characteristic of the automobile being operated in the compliant mode of operation.

Another example of an operating parameter of the automobile is a suspension-parameter. Such a suspension-parameter can be provided by a pressure sensor, a distance/travel sensor, a force sensor, a pressure sensor, or any other sensor that monitors the performance of the suspension system. In the example of a wading mode of operation, the automobile will experience buoyancy when it is in water. This buoyancy will affect the operation of the suspension, and therefore also the suspension-parameter. Therefore, when the automobile leaves the water the suspension-parameter will change back to a value that is more indicative of a compliant mode of operation (i.e. when the automobile is not in deep water). The processor can be configured to recognise this change in the suspension-parameter and, based on the change (optionally in combination with any of the other parameters disclosed herein), automatically switch control of the automobile to the compliant mode of operation.

In a further example still, the operating parameter may be a wading parameter, which can be provided by a wading sensor. For example, a wading sensor may be implemented as an ultrasonic sensor that is configured to determine when the automobile is in sufficiently deep water that it is considered to be wading. The processor can be configured to recognise a change in the wading-parameter from “wading” to “not wading”, and, based on the change (optionally in combination with any of the other parameters disclosed herein), automatically switch control of the automobile to the compliant mode of operation.

In a yet further still example, the operating parameter of the automobile may be an engine-cooling-fan-parameter. Such an engine-cooling-fan-parameter can represent the speed of the engine cooling fan, optionally a current drawn by the engine cooling fan. In the example of a wading mode of operation, the engine cooling fan will experience additional resistance when the automobile is in deep water. This can be reflected by an increased current drawn by the engine cooling fan. Therefore, when the automobile leaves the water the engine-cooling-fan-parameter will change back to a value that is more indicative of a compliant mode of operation (i.e. when the automobile is not in deep water). The processor can be configured to recognise this change in the engine-cooling-fan-parameter and, based on the change (optionally in combination with any of the other parameters disclosed herein), automatically switch control of the automobile to the compliant mode of operation.

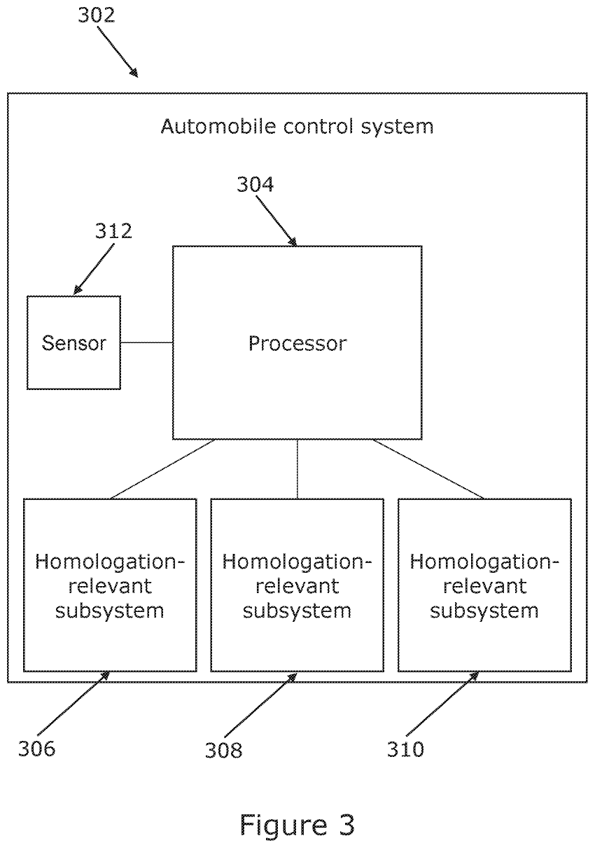

FIG. 3 shows a further example of an automobile control system 302. The automobile control system 302 of FIG. 3 is similar to the automobile control system shown in FIG. 2 in that it comprises a processor 304 and a plurality of homologation-relevant subsystems 306, 308, 310. A difference is that the automobile control system 302 comprises at least one sensor 312 (e.g., a speed sensor) that is configured to sense the operating parameter of the automobile and provide sensor data to the processor. As such, the processor 304 is further configured to determine when the operating parameter exceeds the threshold parameter based on the sensor data, and therefore when it should automatically change operation from the non-compliant mode to the compliant mode.

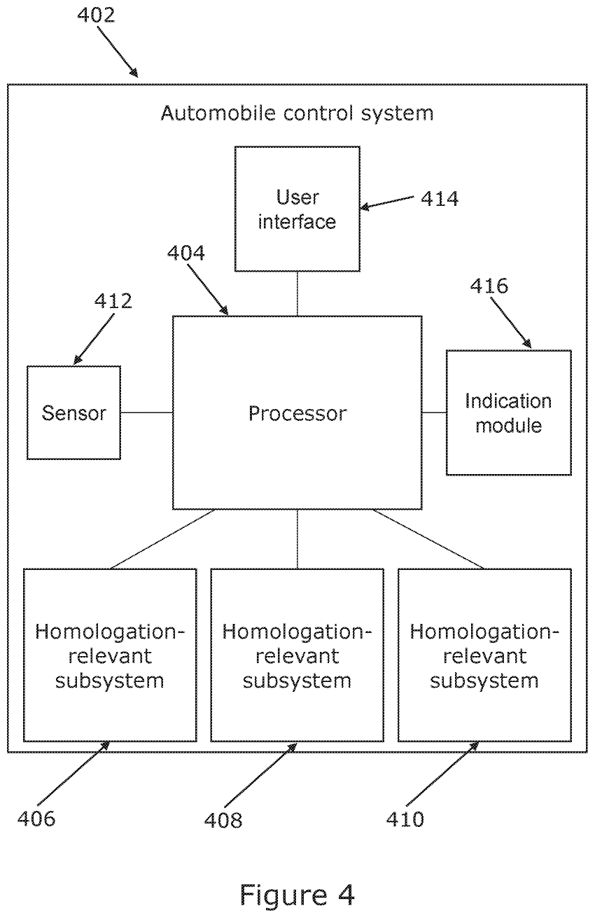

FIG. 4 shows a further example of an automobile control system 402. The automobile control system 402 of FIG. 4 is similar to the automobile control system shown in FIG. 3 in that it comprises a processor 404, a plurality of homologation-relevant subsystems 406, 408, 410 and at least one sensor 412. A difference is that the automobile control system 402 of FIG. 4 comprises a user interface 414 and an indication module 416. In some examples, the user interface 414 and/or the indication module 416 are provided separately to the automobile control system 402.

The processor 404 may be configured to receive one or more user commands via the user interface 414, which may be a button, a switch, a multi-button panel (e.g., a keypad) or a touch-sensitive screen. In some examples, the user interface 414 may include a rocker switch can be used by a user to select an off-road mode or a wading mode of operation. Based on the one or more user commands, the processor 404 may switch control of the automobile from the compliant mode of operation to the non-compliant mode of operation. Based on the one or more user commands, the processor 404 may also select which homologation-relevant subsystems are to be configured so as not to satisfy a homologation requirement. As such, the processor 404 may facilitate user control and customisation of the automobile control system 402 and thus the automobile.

In some examples, the processor 404 may be configured to receive an indication of an operating state (e.g., an engine state or an ignition state) of the automobile. Based on the operating state, the processor 404 can switch the operating mode of the automobile from the compliant mode to the non-compliant mode. For instance, the processor may only switch the operating mode of the automobile from the compliant mode to the non-compliant mode in response to an appropriate user command when the operating state is in a running state. In addition, optionally the processor 404 may only switch the operating mode of the automobile from the compliant mode to the non-compliant mode when the driving speed is less than or equal to a maximum-speed-threshold (which may be 0 km/hr in some examples). In some examples, the processor 404 may receive the operating state from a register that is configured to record when the operating state of the automobile has changed.

In some examples, the processor 404 may be configured to receive a temperature-indicator that represents the engine temperature and/or exhaust system temperature of the automobile. Based on the temperature-indicator, the processor 404 can switch the operating mode of the automobile from the compliant mode to the non-compliant mode. For instance, the processor may only switch the operating mode of the automobile from the compliant mode to the non-compliant mode in response to the temperature-indicator satisfying one or more mode-change-criteria. For instance, the mode-change-criteria may be an upper-temperature-threshold, a lower-temperature-threshold or a range of temperatures. In this way, the processor 404 will only switch the operating mode of the automobile from the compliant mode to the non-compliant mode when the temperature-indicator is: below an upper-temperature-threshold, above a lower-temperature-threshold, or in the range of temperatures. This can be especially relevant when the user is attempting to enter a wading mode of operation, in which case it can undesirable for the automobile to enter deep water if its engine/exhaust system is too hot.

In one implementation, the processor 404 may switch to the non-compliant mode of operation when: the automobile speed is 0 km/hr, the engine is running, and the processor receives two user commands: a first command for ‘setting’ the mode (e.g., by a user pressing a button for at least 3 s) and a second command ‘confirming’ the mode set (e.g., by the user confirming an alert message by touching an appropriate icon on a touchscreen). In this way, the processor 404 may provide an indication of the one or more user commands that it has received to the user. Such an indication (e.g., an alert or acknowledgment) may prompt the user to provide a subsequent user command to the processor 404 that confirms an earlier user command.

When the automobile is in a non-compliant mode of operation, the processor 404 may provide an indication of the operating mode of the automobile to a user. To this end, the indication module 416 may present the indication to the user (e.g., visually, aurally or via haptic feedback) to inform the user of the operation mode. Similarly, the processor 404 may provide an indication of the operating mode of the automobile to a user when the automobile is in a compliant mode of operation.

The processor 404 may automatically switch from the non-compliant mode to the compliant mode of operation in response to the operating state satisfying an associated operating-state-condition (such as the operating state being in an off state). Optionally, the operating-state-condition may require the automobile being off for at least a minimum period of time (which is non-zero, such as 30 s). In which case the processor 404 may determine satisfaction of the operating-state-condition based on the operating state and a clock signal. This functionality may be provided in addition to the processor 404 being able to switch from the non-compliant mode to the compliant mode of operation in response to the user providing a user command (e.g., pressing a button for less than 5 s), and/or the automobile exceeding a threshold speed (e.g., 60 km/hr), as set out above. In some implementations, the processor may switch from the non-compliant mode to the compliant mode of operation in response to the user command irrespective of for how long the user command is provided—that is, there may not be a requirement for the user to press a button for a minimum period of time, in the same way that there may be when switching from the compliant mode to the non-compliant mode.

The automatic switching the operating mode of the automobile from the non-compliant mode to the compliant mode based on an operating state and a minimum period of time may advantageously reduce the likelihood of unexpected automobile behaviour that may follow after quickly re-starting the automobile. For instance if a user stalled the vehicle while in a non-compliant mode, the automobile would remain in the non-compliant mode if they restarted the engine quickly after the stall so that they could continue in the same mode. In contrast, if a user parked up the automobile in a non-compliant mode, and left it for an extended period of time (such as overnight), the automobile would start back up in the compliant mode which is probably what the user would expect (and would likely provide for continued safe operation of the automobile because it would satisfy the necessary homologation requirements). Moreover, the processor 404 may cause the indication module 414 to alert a user of the automobile that there has been a change of the mode of operation by. Such an alert may comprise an exclamation mark displayed on a tell-tale strip, a warning message on an instrument panel cluster, an operating mode light flashing, an acoustic signal, a displayed list of deactivated subsystems or a combination thereof.

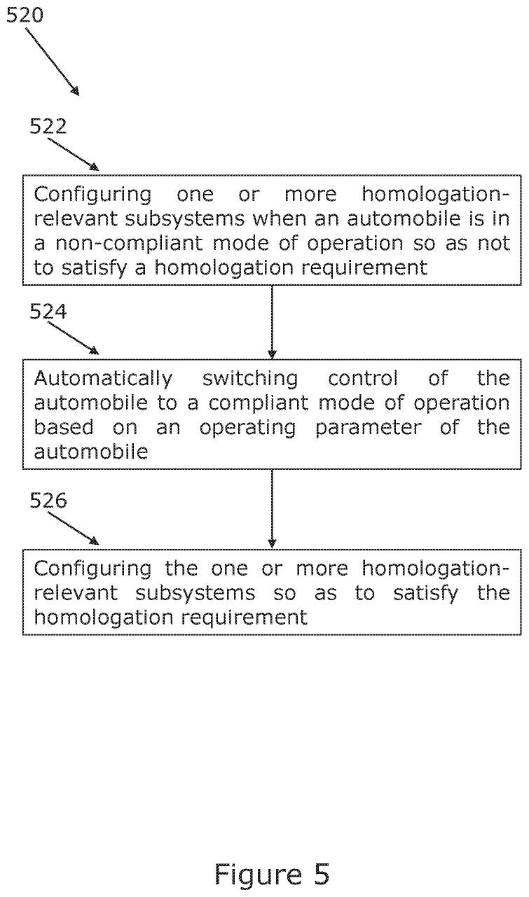

FIG. 5 shows an example method 520 of the present disclosure. The method is for an automobile control system that comprises one or more homologation-relevant subsystems and a processor.

The method comprises configuring 522 the one or more homologation-relevant subsystems of the automobile when the automobile is in a non-compliant mode of operation so as not to satisfy a homologation requirement, automatically 524 switching control of the automobile from the non-compliant mode of operation to a compliant mode of operation based on an operating parameter of the automobile, and configuring 526 the one or more homologation-relevant subsystems of the automobile when the automobile is in the compliant mode of operation so as to satisfy the homologation requirement. Advantages of such processing are discussed in detail above with reference to FIG. 2 in particular.

### DESCRIPTION—MULTI-CORE PROCESSOR

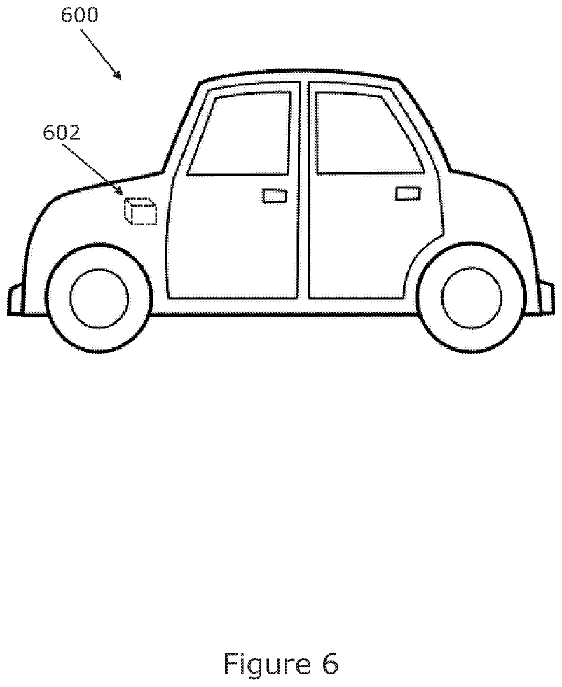

FIG. 6 shows an example automobile 600 comprising an automobile control system 602. The automobile control system 602 comprises a processor and can also comprise at least one safety critical function and at least one non-safety critical function (not shown) of the automobile 600. The processor may be configured for use with the at least one safety critical function and the at least one non-safety critical function.

Throughout the present disclosure, a function may be understood as being ‘safety critical’ if it is vital to the safe operation of the automobile 600. Safe operation may be determined from one or more standpoints: users of the automobile 600, other road users, pedestrians, regulators etc., and may be characterised by factors including compliance with one or more safety ratings, reliability and robustness. Examples of safety critical functions and non-safety critical functions are described later in the present disclosure.

Ensuring safe operation of the automobile 600, for example, also necessitates the automobile control system 602 being safe and reliable. This is because the automobile control system 602 is configured for use with (e.g., to control, handle, serve or otherwise respond to) the at least one safety critical function and the at least one non-safety critical function of the automobile 600. Depending on its architecture, any faults that occur on the automobile control system 602 may cause the at least one safety critical function to function sub-optimally, in particular if the fault corrupts the at least one safety critical function, or results in a processor of the automobile control system 602 not having sufficient resource to service the safety critical function quickly enough.

It has been unexpectedly found that a single multi-core processor can be used to serve both safety critical and non-safety critical functions. Furthermore, such a single multi-core processor can be compliant with the stringent safety requirements of the automotive industry, whereas there has been no teaching or expectation that combining the processing resource for such functions into a multi-core processor could be acceptable.

An objective of one or more embodiments disclosed herein is to provide an automobile control system with improved reliability in respect of any safety critical function(s) that it controls and/or one that is relatively simple to implement.

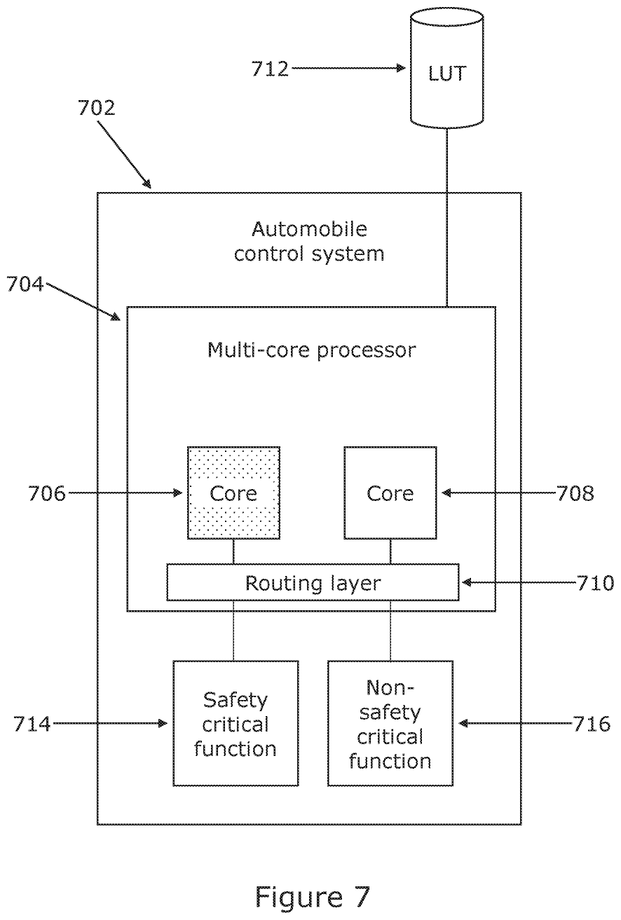

FIG. 7 shows an example schematic of an automobile control system 702. The automobile control system 702 comprises a multi-core processor 704 comprising a plurality of cores 706, 708. Also shown in FIG. 7 is a routing layer 710 and a look-up table (LUT) 712 in communication with the multi-core processor 704. The routing layer 710 represents a functional configuration of the multi-core processor 710, details of which are provided below.

In some examples a database may be provided as an alternative to the LUT 712. Whereas the LUT 712 is illustrated in FIG. 7 as external to the automobile control system 702, in some examples the LUT 712 (or a database) may be provided on a memory (not shown) of the automobile control system 702.

Each core of the plurality of cores 706, 708 may be a physical core provided as a separate processing unit on the die of the multi-core processor 704. In this way, each core may be considered distinct, irrespective of whether the plurality of cores 706, 708 are identical (or near-identical) from a fabrication standpoint.

In the example of FIG. 7, the automobile control system 702 also comprises at least one safety critical function 714 and at least one non-safety critical function 716. The at least one safety critical function 714 is configured to comply with an automotive safety level (ASIL).

Such safety critical and non-safety critical functions may be provided by hardware, software or a combination of hardware and software. In some examples a system (provided as hardware) of the automobile may be configured to call or perform a function. Therefore, a function can be understood as having a corresponding system (e.g., a multimedia system for a multimedia function), to the extent that the corresponding system can call the function. In some examples the at least one safety critical function 714 and the at least one non-safety critical function 716 may be provided by the same system, and/or be provided by separate systems. Such systems may or may not be considered as separate from the automobile control system 702.

At least one core 706 of the plurality of cores 706, 708—highlighted in FIG. 7 by the dotted pattern—is pre-allocated for use with the at least one safety critical function 714. The multi-core processor 704 is configured such that a request from the at least one safety critical function 714 is routed to the least one core 706 that is pre-allocated for use with the at least one safety critical function 714.

At least one other core 708 of the plurality of cores 706, 708—shown in FIG. 7 without any pattern—is pre-allocated for use with the at least one non-safety critical function 716. The multi-core processor 704 may be configured such that a request from the at least one non-safety critical function 716 is routed to the least one other core 708 based on the pre-allocation of the at least one other core 708.

In some examples the multi-core processor 704 may be configured to preclude routing of a request from the at least one non-safety critical function 716 to the at least one core 706 (that is pre-allocated for use with the at least one safety critical function 714). Similarly, the multi-core processor 704 may be configured to preclude routing of a request from the at least one safety critical function 714 to the at least one other core 708 (that is pre-allocated for use with the at least one non-safety critical function 716). In this way the multi-core processor may provide for exclusive processing of requests: the at least one core 706 only handles requests from the at least one safety critical function 714, and the at least one other core 708 only handles requests from the at least one non-safety critical function 716.

The routing layer 710 in this example is configured to receive requests from the safety and non-safety critical functions 714, 716 and, for each request, determine an appropriate core 706, 708 for handling the request. In this way, the routing layer 710 can ensure that the correctly pre-allocated cores 706, 708 are used to service the safety and non-safety critical functions 714, 716. To this end, each request can comprise a request identifier that identifies the sender of the request (e.g., the at least one safety critical function 714). The request identifier corresponds to one of the cores 706, 708 of the multi-core processor 704, such that a core is pre-assigned to the request identifier. The routing layer 710 can check the request identifier of a received request in order to determine to which of the cores 706, 708 to route the request. In this way, the multi-core processor 704 can route the request based on the request identifier.

To determine the correspondence between a request identifier and a core, the routing layer 710 may access information contained in a look-up table, such as the LUT 712, or a database. That is, the multi-core processor can determine which of the plurality of cores 706, 708 to route the request to by accessing the look-up table 712 using the request identifier.

Accordingly, the routing layer 710 enables requests from the at least one safety critical function 714 and the at least one non-safety critical function 716 to be serviced by the correctly pre-allocated core 706, 708 of the multi-core processor 704.

As set out above, the at least one core 706 and the at least one other core 708 are pre-allocated for particular, in some cases dedicated, uses. In combination with the routing layer 710 competition between the processing of requests from safety and non-safety critical functions may thus be avoided. Furthermore, if a fault develops on one core (e.g., the core pre-allocated for non-safety critical function use), operations performed by the other core (that is pre-allocated for safety critical function use) will not be affected. Further advantages will become apparent from the following discussion of the safety considerations of the present disclosure.

In the example of FIG. 7 the at least one safety critical function 714 is configured to comply with an ASIL. For the purposes of the present disclosure, ASIL compliance can be a characteristic of the at least one safety critical function 714 and not necessarily its implementing hardware.

In general terms, ASIL compliance may comprise satisfying a safety rating (e.g., mean time to failure) against the risks(s) and hazard(s) associated with the ASIL. As such the ASIL may be a specific ASIL; for example, one of A, B, C or D as defined under ISO 26262. In some examples the at least one non-safety critical function 716 does not comply with a specific ASIL.

Accordingly, routing a request from a safety critical function to a specific core can enable a request to be processed in a quick and efficient manner. Consider an example where the multi-core processor receives two processing requests: one from the non-safety critical function 716 (e.g., a request to access media); and another from the safety critical function 714 (e.g., a request to deploy an airbag). In the example of FIG. 7, the processing for the safety critical function is 714 handed by the core 706 that is pre-allocated for use with at least one safety critical function. Similarly, the processing for the non-safety critical function 716 is handed by the other core 708 (which is pre-allocated for use with at least one non-safety critical function). In this way, the processing resource that is required by the non-safety critical function 716 does not negatively impact the ability of the multi-core processor 704 from being able to service the safety critical function 714. This can enable safety critical functions 714 that are time critical, such as a request to deploy an airbag, to be serviced by the multi-core processor 704 in such a way that the associated ASIL rating remains satisfied.

The at least one safety critical function may be selected from (or otherwise correspond to) the group at least consisting of but not limited to: an airbag function, a brake function, an engine temperature warning function, a tyre pressure monitor, an engine warning function, a battery warning function, an oil level monitor, a coolant level monitor, an electronic stability control function, an advanced driver assistance system (ADAS) video processing function and an emergency telephony function. The at least one non-safety critical function may be selected from (or otherwise correspond to) the group consisting of but not limited to: a multi-media function, an AM/FM radio, a digital radio, a global navigation satellite receiver, a wireless router, an audio function, a body control module, a rear view camera, a clock and a USB hub. The skilled person will appreciate that comparable advantages to the airbag example provided above can be realised for other types of safety critical function.

Use of the multi-core processor 704 can advantageously avoid the need for a plurality of separate processors. Use of such a plurality of separate processors may result in an unduly complex automobile control system architecture. Use of a multi-core processor 704 with both safety and non-safety critical functions can represent a relatively uncomplicated solution, which surprisingly can meet one or more safety requirements set by automotive industry regulators.

By way of comparison, an automobile control system comprising a single core processor would, if a fault developed on the core, affect both the non-safety critical and the safety critical functions. Also, a safety critical function may be denied processing resource until a non-safety critical function has been completed. Such scenarios may be unacceptable from a safety standpoint.

One or more embodiments of automobile control systems as set out in the present disclosure may therefore offer an improvement over other automobile control systems by reducing the effects of core failure within function sets of an automobile. In addition, such one or more embodiments can offer consolidated processing of signals on a single processor, and may also—
allow for multiple dedicated cores for different automobile functions, mitigating (from a safety standpoint) risks associated with using one processor core for all automobile functions;
facilitate resource management (load distribution) between and within core sets, an aspect of the disclosure that is discussed in detail below;
allow for the pre-allocation of cores to be tailored to the ASIL compliance of safety-critical functions; and/or
facilitate automobile control system operation using a dedicated instruction set (exemplified here by the routing layer) for a multi-core processor.

In some examples, the multi-core processor 704 may be configured to process requests from the at least one safety critical function 714 and the at least one non-safety critical function 716 simultaneously via the plurality of cores 706, 708. In other words, the multi-core processor 704 can provide processing power for both the at least one safety critical function 714 and the at least one non-safety critical function 716 at the same time, without having to alternate between providing processing power to one of the types of function before it can provide processing power to the other type of function.

The at least one core 706 may be configured to receive an operating state of the at least one safety function 714 and provide an indication of the operating state for display to a user of the automobile. The at least one other core 708 may be configured in a similar manner in respect of the at least one non-safety function 716. Additionally, or alternatively, the cores 706, 708 may provide the indications for aural and/or haptic presentation to a user of the automobile. These indications may facilitate user awareness of the operational states of the functions served by the automobile control system, and/or user operation of the automobile. Examples of such indications include a low brake fluid level indicator, an engine temperature warning indicator (e.g. because the temperature falls outside of a normal operating range) and a flat battery indicator.

In the same or other examples, a core may be configured to perform a calculation based on an operating state. Based on the calculation, the core may provide an instruction for another function or system of the automobile. For example, based on an operating state of a safety critical function (e.g., an engine temperature warning function), the at least one core pre-allocated for use with the safety critical function may calculate a risk rating. If the risk rating is above a threshold, the core may generate and send an instruction to an engine control unit in order to mitigate the risk.

To allow for the display of operating state indications as set out above, each core may be configured to provide their respective indication(s) for display on one or more displays, as set out later in the present disclosure.

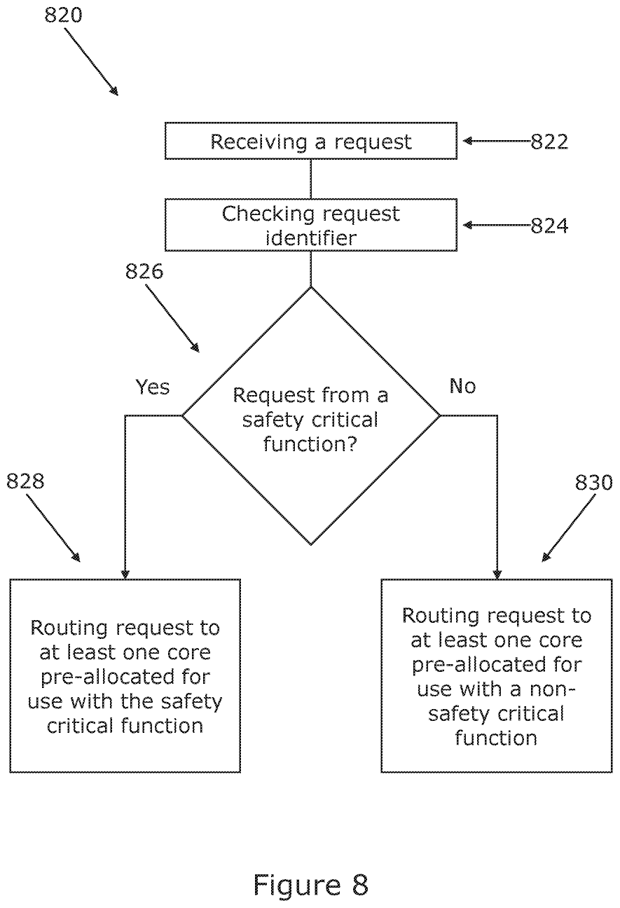

FIG. 8 shows an example method 820 of the present disclosure, which can correspond to the functionality of the routing layer that is described with respect to FIG. 2.

The method comprises receiving 822 a request from a function of the automobile control system. As set out above, the request can include a request identifier that is representative of the function that generated the request. The method continues by checking 824 the request identifier. Again, as set out above, the step of checking 824 may comprise looking up the request identifier in a look-up table or database to determine a core identifier that is associated with the received request identifier.

Step 826 is shown schematically as determining, based on the request identifier, whether or not the request is from a safety critical function. Then at step 828, if it is determined that the request is from a safety critical function, the method involves routing the request to at least one core pre-allocated for use with the safety-critical function. Alternatively, at step 830, if it is determined that the request is not from a safety critical function, the method involves routing the request to at least one core pre-allocated for use with a non-safety critical function. It will be appreciated that the functionality of steps 826, 828 and 830 may be implemented by the method simply routing the request to the core that has the core identifier that is returned from the LUT at step 824. In this way, the determination of whether or not the request is from a safety critical function is implicitly embodied by the specific core identifier that is returned from the LUT as being associated with the request identifier.

Advantages arising from this method can be understood with reference to the examples provided in relation to FIG. 7.

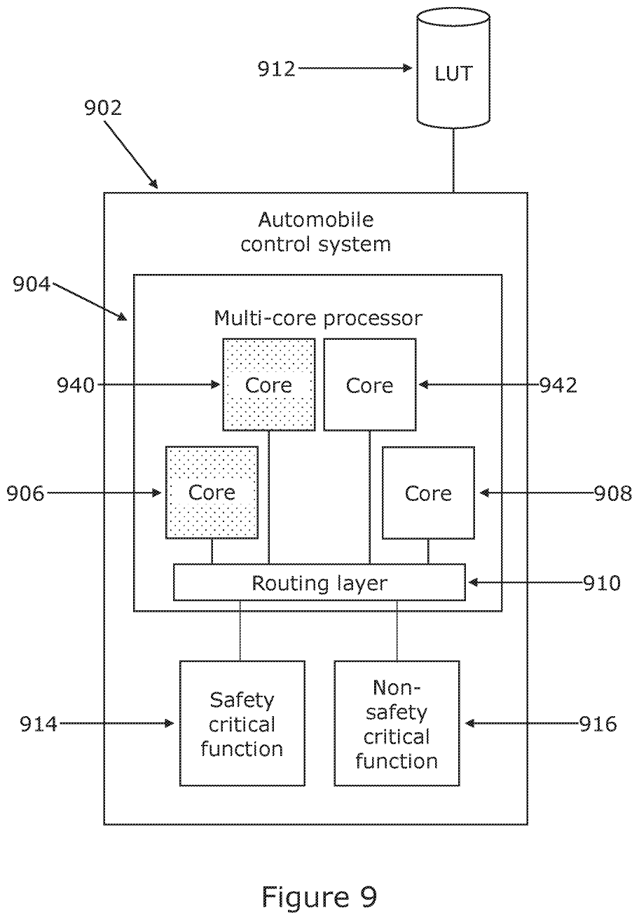

FIG. 9 shows a further example of an automobile control system 902. The automobile control system 902 of FIG. 9 is similar to the automobile control system shown in FIG. 2 in that it comprises a multi-core processor 904 comprising a plurality of cores 906, 908, a routing layer 910, a LUT 912, at least one safety critical function 914 and at least one non-safety critical function 916. A difference is that the multi-core processor 904 comprises two cores 906, 940 pre-allocated for use with the at least one safety critical function 914 and two cores 908, 942 pre-allocated for use with the at least one non-safety critical function 916. Hence, in this example, the multi-core processor 904 is a quad-core processor.

In examples where two or more cores are pre-allocated for a particular use, these cores may be described as belonging to an identifiable core set. To this end, a core set may be identified using a core set identifier.

For example, two cores 906, 940 pre-allocated for use with at least one safety critical function 914 may be described as belonging to a core set with the core set identifier ‘safety critical’. Similarly, two cores 908, 942 pre-allocated for use with at least one non-safety critical function 916 may be described as belonging to a core set with the core set identifier ‘non-safety critical’. The skilled person will understand that these identifiers are merely exemplary and that alternatives (including alternative formats) can also be used.

Core set identifiers may be stored alongside, or instead of, request identifiers in the LUT 912. The routing layer 910 may be configured to determine a core set identifier that corresponds to a given request identifier by accessing the LUT. From this, the routing layer 910 may identify a core set that is pre-allocated for receiving the request. The routing layer 910 may then determine a specific core within the core set for handling the request routing using any technique that is known in the art.

Using core sets (comprising a plurality of cores that are pre-allocated for the same type of function) may advantageously facilitate efficient processor load management on a multi-core processor. Consider as one example a routing layer 910 that receives several safety critical functions simultaneously. If these requests were routed to a single processor (or a single core) configured for use with the safety critical functions, then the available processing power may be insufficient to meet the required demand. As such, a bottleneck may form that limits the ability of the multi-core processor to process safety critical requests expediently. This may risk automobile and/or user safety if these safety critical functions are time critical.

Instead, by initially routing a request to a core set that is pre-allocated for servicing a safety critical function, the selection of a specific core that is available to process a request can be facilitated. In this way, processing bottlenecks may be avoided or reduced by sharing the processing load between multiple cores that are pre-allocated for a particular use (e.g., for use with safety critical functions). Furthermore, if a fault develops on one core within a core set, the remaining cores may continue to process requests (e.g., in a backup capacity).

In the example of FIG. 9 the multi-core processor is shown with four cores: two pre-allocated for use with safety critical functions and two pre-allocated for use with non-safety critical functions. In other examples, the multi-core processor 904 may comprise at least four cores, optionally six, pre-allocated for use with the at least one non-safety critical function 912 (i.e., the processor may be an octo-core processor with a 4/4 or 6/2 split between cores pre-allocated for non-safety and safety critical functions respectively). In this way, the number of cores of the multi-core processor 904 pre-allocated for use with either the at least one safety critical function 914 or the at least one non-safety critical function 916 may be chosen based on the number of safety critical and non-safety critical functions and their respective processing requirements.

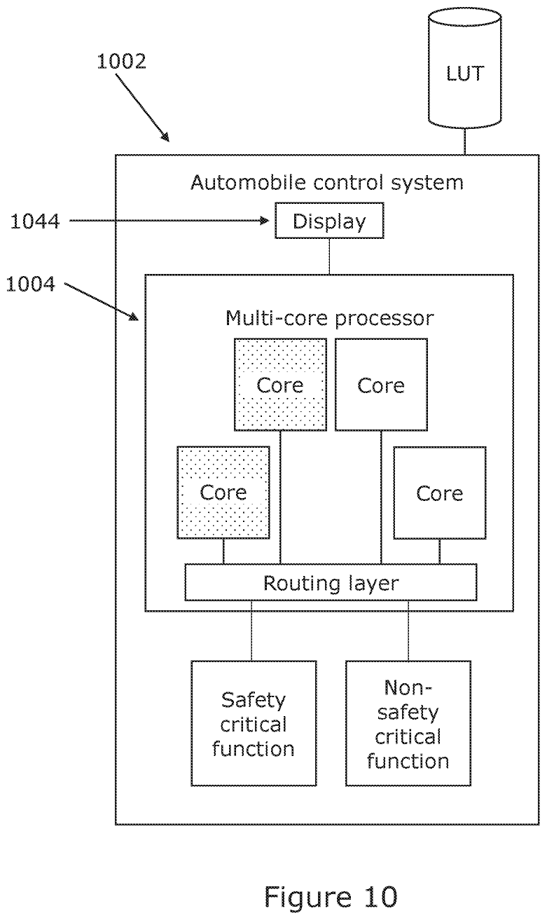

FIG. 10 shows a further example of an automobile control system 1002. While the automobile control system 1002 of FIG. 10 is similar to the automobile control system shown in FIG. 9, a difference is that the automobile control system 1002 comprises at least one display 1044, which may be selected from the group consisting of an analogue readout, a digital readout, a telltale strip, a screen, and a heads-up display. In other examples, the at least one display may be considered as separate to the automobile control system.

The at least one display 1044 is configured to display the indication of the safety critical function operating state (e.g., displaying a warning sign) and the indication of the non-safety critical function operating state (e.g., displaying a text message). These indications may be displayed in the same or different areas of a single display, or on different displays.

In some examples, the automobile control system 1002 may comprise a first display and a second display. In such examples, the first display can be configured to display the indication of the safety critical function operating state. The second display can be configured to display the indication of the safety critical and/or non-safety critical function operating state. Alternatively, or in addition, a given indication may be shared, duplicated or replicated across each display.

Each display of the first and second displays may be of the same type or of a different type. For example, the first display may be an analogue readout and the second display may be a screen. Both displays, however, are controlled by the same processor (i.e., the multi-core processor 1004).

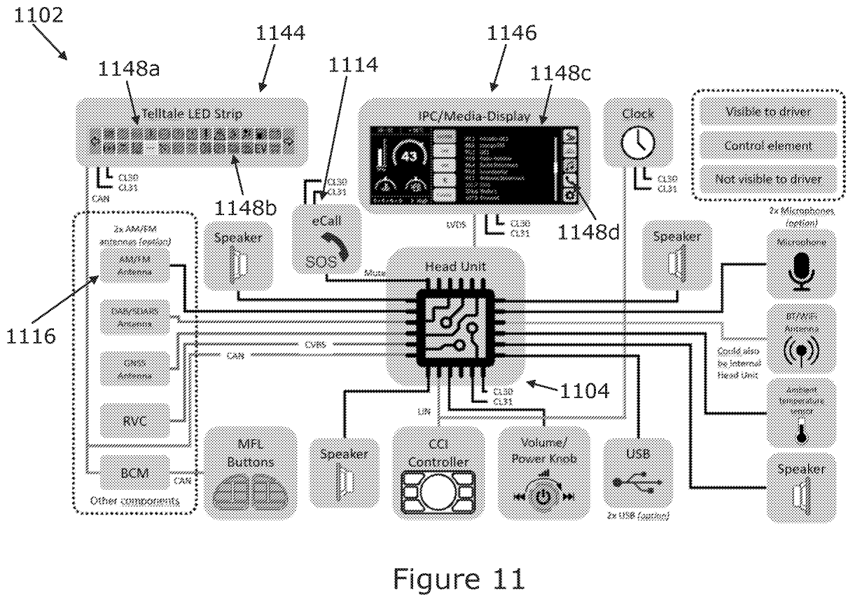

FIG. 11 shows a further example schematic of an automobile control system 1102. The automobile control system 1102 comprises a multi-core processor (‘Head Unit’) 1104, at least one safety critical function 1114 (‘eCall SOS’), at least one non-safety critical function 1116 (‘AM/FM Antenna’), a first display 1144 (‘Telltale LED strip’—shown here as a non-limiting example of the display of the automobile control system of FIG. 10) and a second display 1146 (‘IPC/Media-Display’). FIG. 11 includes various features that can be provided with one or more of the other examples disclosed herein. It will be appreciated that the features of FIG. 11 can be provided independently of other features of FIG. 11 with which they are not inextricably linked.

The first display 1144 is configured to display indications 1148a,b of safety critical function operating states. The second display 1146 is configured to display an indication 1148c of the operating state of the at least one non-safety critical function 1116 and, in this example, also an indication 1148d of the at least one safety critical function 1114.

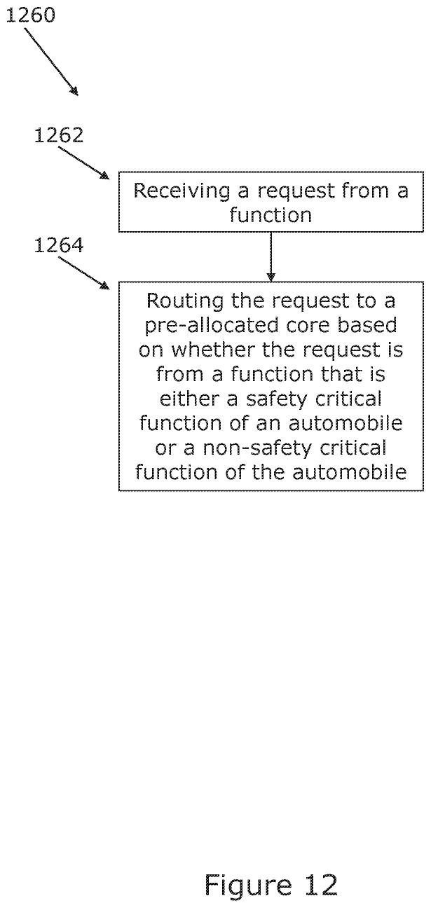

FIG. 12 shows an example method 1260 of the present disclosure. The method is for an automobile control system, which comprises a multi-core processor. The multi-core processor includes a plurality of cores.

The method comprises receiving 1262 a request from a function, and routing 1264 the request to a pre-allocated core of the plurality of cores based on whether the request is from a function that is either: a safety critical function of an automobile, or a non-safety critical function of the automobile. As discussed above, the at least one safety critical function is configured to comply with an automotive safety integrity level, ASIL. Advantages of this method are discussed in detail above with reference to FIG. 7 in particular.

1. An automobile control system comprising:
one or more homologation-relevant subsystems; and
a processor configured to:
configure the one or more homologation-relevant subsystems of an automobile when the automobile is in a non-compliant mode of operation so as not to satisfy a homologation requirement;
automatically switch control of the automobile from the non-compliant mode of operation to a compliant mode of operation based on an operating parameter of the automobile; and
configure the one or more homologation-relevant subsystems of the automobile when the automobile is in the compliant mode of operation so as to satisfy the homologation requirement.

2. The automobile control system of claim 1, wherein:
configuring the one or more homologation-relevant subsystems of the automobile when the automobile is in the compliant mode of operation comprises one of activating, enabling, or initiating for operation the one or more homologation-relevant subsystems, and
configuring the one or more homologation-relevant subsystems of the automobile when the automobile is in the non-compliant mode of operation comprises one of deactivating, disabling, disengaging or inhibiting from operation the one or more homologation-relevant subsystems.

3. The automobile control system of claim 1, wherein satisfying or not satisfying the at least one homologation requirement comprises complying or not complying with the homologation requirement.

4. The automobile control system of claim 1, wherein the homologation requirement is a legal requirement based on an emissions standard, a safety standard, or an ISO standard or a combination thereof.

5. The automobile control system of claim 1, wherein the one or more homologation-relevant subsystems is selected from the group consisting of advanced driver-assistance system, an air bag system, an automatic transmission lock, a camera system, a diesel particulate filter, a door status detection system, a dynamic stability control system, an electronic stability program, a gasoline particulate filter, a lighting system, a parking distance control system, a parking lock, a seatbelt indicator and a stop-start system.

6. The automobile control system of claim 1, wherein the processor is configured to:
receive the operating parameter of the automobile;
determine when the operating parameter exceeds a threshold parameter; and
automatically switch control of the automobile from the non-compliant mode of operation to the compliant mode of operation when the operating parameter exceeds the threshold parameter.

7. The automobile control system of claim 6, wherein the operating parameter is a speed of the automobile, and the threshold parameter is a threshold speed parameter.

8. The automobile control system of claim 7, wherein the threshold speed parameter is at least 5 km/hr.

9. The automobile control system of claim 6, comprising at least one sensor configured to:
sense the operating parameter of the automobile; and
provide sensor data to the processor,
wherein the processor is configured to:
receive the sensor data from the sensor; and
determine when the operating parameter exceeds a threshold parameter based on the sensor data.

10. The automobile control system of claim 1, wherein the non-compliant mode of operation comprises the automobile being on.

11. The automobile control system of claim 1, wherein the processor is configured to:
receive an indication of an operating state of the automobile; and
switch control of the automobile from the non-compliant mode of operation to the compliant mode of operation based on the operating state satisfying an operating-state-condition.

12. The automobile control system of claim 11, wherein satisfying the operating-state-condition requires the operating state being in an off state for at least a minimum period of time.

13. The automobile control system of claim 1, wherein the processor is configured to provide an indication to a user of the automobile when automatically switching control of the vehicle from the non-compliant mode of operation to the compliant mode of operation.

14. (canceled)

15. A computer-implemented method of controlling an automobile, the automobile comprising one or more homologation-relevant subsystems, the method comprising:
configuring the one or more homologation-relevant subsystems of the automobile when the automobile is in a non-compliant mode of operation so as not to satisfy a homologation requirement;
automatically switching control of the automobile from the non-compliant mode of operation to a compliant mode of operation based on an operating parameter of the automobile; and
configuring the one or more homologation-relevant subsystems of the automobile when the automobile is in the compliant mode of operation so as to satisfy the homologation requirement.

16. (canceled)

17. An automobile control system comprising:
a multi-core processor comprising a plurality of cores,
wherein:
at least one core of the plurality of cores is pre-allocated for use with at least one safety critical function of an automobile, the at least one safety critical function configured to comply with an automotive safety integrity level, ASIL,
at least one other core of the of the plurality of cores is pre-allocated for use with at least one non-safety critical function of the automobile, and
the multi-core processor is configured to route a request from the at least one safety critical function to the at least one core that is pre-allocated for use with the at least one safety critical function.

18. The automobile control system of claim 17, wherein:
the request comprises a request identifier identifying the at least one safety critical function, and
the multi-core processor is configured to route the request based on the request identifier.

19. The automobile control system of claim 18, wherein the multi-core processor is configured to determine which of the plurality of cores to route the request to by accessing a look-up table using the request identifier.

20. The automobile control system of claim 17, wherein the multi-core processor is configured to route a request from the at least one non-safety critical function to the at least one other core.

21. The automobile control system of claim 17, wherein the multi-core processor is configured to preclude routing of a request from the at least one non-safety critical function to the at least one core that is pre-allocated for use with the at least one safety critical function.

22. The automobile control system of claim 17, wherein the ASIL of the function is one of A, B, C or D as defined under ISO 26262.

23-32. (canceled)
